(19) United States
(12) Patent Application Publication
(10) Pub. No.: US 2008/0173820 A1
(43) Pub. Date: Jul. 24, 2008

(54) PORTABLE RADIATION DETECTION APPARATUS AND SPECTROMETRIC ANALYSIS METHOD

(75) Inventors: Hsun-Hua Tseng, Taoyuan County (TW); Chun-Shih Yang, Taoyuan County (TW)

Correspondence Address: WPAT, PC, 7225 BEVERLY ST., ANNANDALE, VA, 22003, US

(73) Assignee: Institute of Nuclear Energy Research Atomic Energy Council, Executive Yuan, Taoyuan (TW)

(21) Appl. No.: 11/847,412

(22) Filed: Aug. 30, 2007

(30) Foreign Application Priority Data
Nov. 10, 2006 (TW) 095141609

(51) Int. Cl. G01T 1/20; G06F 19/00

(52) U.S. Cl. 250/369; 702/70

(57) ABSTRACT

A portable radiation detection apparatus is provided to transform detected radioactivity into an analog pulse signal and then convert the analog pulse signal into a digital pulse signal. Thereafter, a counting information with respect to the pulse width and pulse counting of the digital pulse signal is created for data processing executed in a portable device. A spectrometric analysis method is provided, which comprises the steps of generating a smooth and continuous curve with respect to the counting information, searching peak values and channel numbers corresponding to the peak values toward the smooth and continuous curve, calculating FWHM and region of interest of the peak values and then processing counting rate process. According to the foregoing characteristics, the present invention is not only provide lowing cost and wireless communication but also provide distance protection for radiation protection personnel to execute the inspection routinely under the extremely environment.

### FIELD OF THE INVENTION

The present invention is related to a radiation detection apparatus and spectrometric analysis method, and, more particularly, to a portable radiation detection apparatus and spectrometric analysis method which directly converts an electrical pulse generated by a radioactive detecting unit into a logical pulse through a signal processing unit without pulse shaping and then performs spectrometric analysis according to information of pulse width and counts with respect to the logical pulse.

### BACKGROUND OF THE INVENTION

Radiation detection and measurement is a vital stage in the field of nuclear engineering. Owing to the gradually development of the radioactive technology application in all respects and widespread use of the radiation detection systems, the demand of the radiation detection system is highly concerned. Radiation detection system detects the counts of various effects, which are caused by the nuclear radiation, and, by means of the energy transfer, sample will be transformed due to the radioactive action.

The radiation detection system, generally, comprises a detector, a nuclear instrument module, a controlling system and a data access and storage unit. The controlling system and the data access and storage unit are usually integrated within a unit, which is usually referred to a personal computer or a server, for example. The pulse height of the output signal of the detector is direct proportion to the energy of the radioactive rays. The output signal of the detector is input into a low noise and electro-sensitive pre-amplifier and then is transmitted to a linear amplifier. After that, the output of the linear amplifier is transmitted to a multi-channel pulse-height analyzer, which is capable of drawing a complete spectrum and analyzing the component of the sample in a short time.

Currently, the platform for system operation in often is a personal computer or a server. The merits of the personal computer or the server are not only to provide a better human-machine interface but also to utilize large size memory for data storage and data operation and processing, which are not affordable for a single nuclear instrument module in the conventional arts.

In addition, the data format for computer or server is capable of being transferred to other computer or server platform easily so the computer or server is widely utilized in the radiation detection system. However, the computer or server is bulky and lacks mobility. Although the computer or server may be combined within a vehicle to increase the mobility, or be replaced by a Notebook or laptop with standard communication protocol interface, it still doesn't have enough maneuverability for operation.

Hence, a portable radiation detection system gradually becomes the major target for the development of the radiation detection system. In the current market, indeed, various kinds of products of portable radiation detection system are made for radiation detection. Among those portable detection systems, the conventional portable detection system, such as digiDART of ORTEC and InSpector 1000 of CANBERRA, generally speaking, comprises a detection interface, a data processing unit and a display interface, which are capable of detecting the type of radioactive nuclide in the environment, acquiring the spectrum, displaying and storing data.

The foregoing conventional portable radiation detection system can not perform spectrometric analysis on the display directly, which is limited to the kernel of the data processing unit. In the conventional arts, the kernel of the data processing unit is a single chip micro-controller, which has a limited calculation capability and limited memory size for storing a controlling program. Meanwhile, data search for different radioactive nuclides is impossible in such system; therefore, conventional arts of portable radiation detection system still have to rely on the capability of computer or server for performing spectrometric analysis, transmitting data, and monitoring remotely.

Besides, the user interface for operation is still necessary to be improved in the foregoing portable radiation detection systems. Although, so far, a colorful display is built in the portable radiation detection systems, limited to the operation platform in such system, the cursor for selecting function in those conventional systems can just only be controlled by the keyboard. On the other hand, in the era full of window-based software, conventional portable radiation detection systems without an operation system can't provide powerful functions for data processing and the display for showing the spectrum thereof is dull as well.

The conventional radiation detection apparatus in the market are characterized in that the detecting interface, data processing unit, and storage and display interface which are all integrated in the same circuit board. Although the bulk of the portable radiation detection apparatus is improved, it still has drawbacks of inflexibility for expanding another modules, and inconvenience for system maintenance. Generally speaking, the display of the conventional portable radiation detection system is commonly out of order due to the environment causes such as high temperature or the humidity. Although the other module is functioning well, due to the integrated design in the conventional detection products, the user should replace the whole system with a new one even if only the display is broken.

As a result, a portable radiation detection apparatus and a spectrometric analysis method are needed for solving the problems arisen from the conventional arts.

### SUMMARY OF THE INVENTION

A primary objective of the present invention is to provide a portable radiation detection apparatus wherein a portable electrical device, having a capability of wireless communication, is integrated to a radioactive detecting unit for performing a remote data processing so as to achieve a purpose of providing a convenience and a distance protection for radiation protection personnel, executing the inspection routinely and performing experiment under the extremely environment.

Another objective of the present invention is to provide a portable radiation detection apparatus and a spectrometric analysis in which the portable radiation detection apparatus directly converts an electrical pulse generated by a radioactive detecting unit into a logical pulse through a signal processing unit without pulse shaping and then performs spectrometric analysis according to information of pulse width and counts with respect to the logical pulse so as to achieve a purpose of simplifying the apparatus design and lowering the production cost.

A further objective of the present invention is to provide a portable radiation detection apparatus and a spectrometric analysis wherein a pulse width is defined to be an energy channel representing magnitude of a pulse peak value converted by a converting circuit after a detected pulse signal is converted. Hence, larger pulse peak value generated from a high energy radioactive material corresponds to higher pulse width and higher channel, in which, for each energy channel, counts accumulated by a counter represents energy accumulation of the radioactive material in the surrounding. Since a relationship between the pulse peak value and the pulse width is exponential, it may further provide the operator to analyze the spectrometry so as to determine an activity of the radioactive element in the surrounding.

Another further objective of the present invention is to provide a portable radiation detection apparatus and a spectrometric analysis wherein an energy counting information obtained by the portable radiation detection apparatus is processed by smoothing the energy counting information; searching at least one peak position automatically or manually and corresponding channel; and calculating a region of interest and a net counting rate for purpose of analyzing and determining nuclides.

For achieving the foregoing purposes, the present invention provides a portable radiation detection apparatus, comprising: a detecting unit for absorbing radioactive particles so as to generate an analog signal; a signal processing unit, coupled to the detecting unit, for converting the analog signal into a logical pulse; a measuring and counting unit, coupled to the signal processing unit, for measuring pulse width and counting pulse counts of the logical pulse so as to form an energy counting information; and a portable electrical device, coupled to the measuring and counting unit, for receiving the energy counting information for post processing.

Preferably, the detecting unit further comprising: a scintillation detector; and a photomultiplier tube connected to the scintillation detector wherein the scintillation detector is a NaI scintillation detector. Meanwhile the signal processing unit further comprising: a high voltage power supply, coupled to the detecting unit, for providing operating voltage to the photomultiplier tube so that the photomultiplier tube is capable of converting optical pulse generated from radioactive energy absorbed by the scintillation detector into the analog pulse signal; and a discriminator circuit for filtering noises of the analog pulse signal and converting the analog pulse signal into the logical pulse.

More preferably, the portable electrical device may be a personal digital assistance, a cellular phone or a smart phone.

More preferably, the measuring and counting unit further comprising: a clock pulse generator for generating at least one clock pulse; and a pulse counter unit, further including: a counter for receiving the clock pulse and the logical pulse so that the count is capable of taking the logical pulse as a gating signal and taking the clock pulse as an input source for counting so as to form the energy counting information; and a buffer memory, coupled to the counter and the portable electrical device, for storing the energy counting information. The counter further includes a high energy pulse counter and a low energy pulse counter.

More preferably, the energy counting information further includes a high energy counting information and low energy counting information.

For achieving the foregoing purpose, a method for spectrometric analysis comprising steps of: providing an energy counting information acquired by a portable radiation detection apparatus; smoothing the energy counting information so as to form a continuous smooth curve; searching at least one peak position from the continuous smooth curve, wherein each of the peak position has a corresponding peak value; calculating a region of interest with respect to each of the peak value; and calculating a net counting rate according to the region of interest for each of the peak value.

More preferably, the step of searching at least one peak position further comprising the steps of: differentiating the continuous smooth curve for searching peaks of the continuous smooth curve; and determining if the selected peak is the peak position or not wherein algorithm for determining if the selected peak is the peak position or not is a Full Width Half Maximum algorithm.

More preferably, the step of searching at least one peak position further comprising the steps of: selecting peak from the continuous smooth and calculating peak value corresponding to the selected peak; and determining if the selected peak is the peak position or not, wherein algorithm for determining if the selected peak is the peak position or not is a Full Width Half Maximum algorithm.

More preferably, the method further comprises a step of calibrating energy, wherein the calibrating further comprises steps of: selecting a nuclide for calibrating; and modifying the energy and channel information corresponding to the selected nuclide.

### BRIEF DESCRIPTION OF THE DRAWINGS

The drawings, incorporated into and form a part of the disclosure, illustrate the embodiments and method related to this invention and will assist in explaining the detail of the invention.

FIG. 1 is a preferred embodiment of the portable radiation detection apparatus according to the present invention.

FIG. 2 illustrates a detecting unit of the portable radiation detection apparatus according to the present invention.

FIG. 3 is a preferred embodiment of spectrometric analysis method according to the present invention.

FIG. 4 illustrates the result of Eu-152-0308, ¹⁵²Eu, according to the energy counting information.

FIG. 5 illustrates the result of the automatic searching peak position according to the present invention.

FIG. 6 shows the calculating result of the FWHM of the ¹⁵²Eu.

FIG. 7 illustrates a distribution of the spectrum, which is an independent full energy peak formed on the background or Compton continuous area.

FIG. 8 is a flow chart of the calibrating energy according to the present invention.

### DESCRIPTION OF THE PREFERRED EMBODIMENT

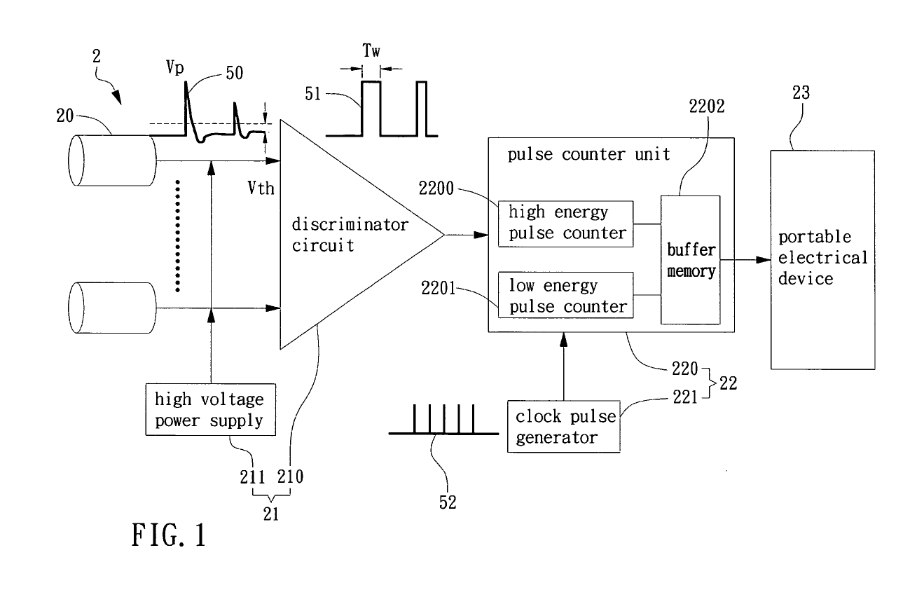

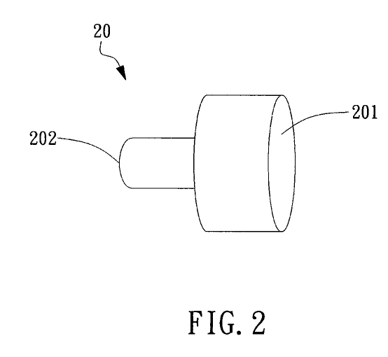

Please refer to FIG. 1, which is a preferred embodiment of the portable radiation detection apparatus according to the present invention. The portable radiation detection apparatus 2 comprises a detecting unit 20, a signal processing unit, 21, a measuring and counting unit 22, and a portable electrical device 23. The detecting unit 20 functions to absorb radioactive particles so as to generate an analog signal 50. An embodiment of the detecting unit 20 shown in FIG. 2 includes a scintillation detector 201 and a photomultiplier tube 202, which connects to the scintillation detector 201. In the embodiment, the scintillation detector 201 is NaI scintillation detector, but should not be limited to NaI.

Back to FIG. 1, the signal processing unit 21, coupled to the detecting unit 20, functions to convert the analog signal 50 into a logical pulse 51. In the embodiment, the signal processing unit 21 further has a high voltage power supply 211 and a discriminator circuit 210. The high voltage power supply 211, coupled to the detecting unit 20, is capable of providing an operating voltage to the photomultiplier tube 202 so that the photomultiplier tube 202 is capable of converting optical pulse generated from radioactive energy absorbed by the scintillation detector 201 into the analog pulse signal 50. The discriminator circuit 210 is capable of filtering noises of the analog pulse signal 50 and converting the analog pulse signal 50 into the logical pulse 51. In the present embodiment, the power requirement for the discriminator circuit 210 is 5 volts and the output pulse separation is between 30˜50 μs. Meanwhile, the discriminator circuit 210 is capable of outputting high-energy pulse and low-energy pulse simultaneously, wherein the basic unit of the pulse width thereof is 0.5 μs.

The discriminator circuit 210 utilizes a comparator with a default low limit level to discriminate a shaped radioactive pulse from noise signal and the shaped radioactive pulse is then transformed directly into the logical pulse 51. Please refer to the following equation (1), in which, when the default low limit level inside the comparator of the discriminator circuit 210 is Vth, the pulse width Tw of the logic pulse 51 after discrimination can be shown in the equation (2).

$$\begin{matrix}\begin{matrix}V ( t ) = {V}_{dc} + {V}_{n} ( t ) t < 0 \\ = {V}_{pk} \cdot {e}^{- t / τ} + {V}_{dc} + {V}_{n} ( t ) t \geq 0\end{matrix} & ( 1 ) \\ \begin{matrix}{T}_{w} = τ \cdot ln ( {V}_{pk} / ( {V}_{th} - {V}_{n} ( {T}_{w} ) - {V}_{dc} ) ) \\ = τ \cdot ln ( {V}_{pk} / {V}_{th}^{′} )\end{matrix} & ( 2 )\end{matrix}$$

On the other hand, if the pulse width of the logic pulse 51 is notated as Tw, then the corresponding height of the radioactive pulse Vpk can be obtained according to the equation (3) below, wherein the Vth′ is a real critical discriminated pulse height.

$${V}_{pk} = ( {V}_{th} - {V}_{n} - {V}_{dc} ) \cdot {e}^{{T}_{w} / τ} ≅ {V}_{th}^{′} \cdot {e}^{{T}_{w} / τ} \qquad ( 3 )$$

During applying the way described above to detect pulse height, if the noise voltage Vn<<Vth−Vdc shown in equation (3) and base voltage is stable, then the relationship between the precision of pulse width detecting dTw, a pulse period of the counter equal to 1/Fc, wherein Fc is the frequency of counter, and a time constant “t” of the shaped radioactive pulse toward to relative resolution rate of pulse height (dVpk/Vpk) can be described in the following equation (4) due to the exponential relationship between pulse height and width.

$$\frac{d Vpk}{Vpk} = \frac{d Tw}{τ} = \frac{1}{τ \cdot Fc} \qquad ( 4 )$$

The measuring and counting unit 22 is coupled to the signal processing unit 21 for measuring pulse width and counting pulse counts of the logical pulse 51 so as to form an energy counting information. The measuring and counting unit 22 has a clock pulse generator 221 and a pulse counter unit 220. The clock pulse generator 221 functions to generate at least one clock pulse 52. The pulse counter unit 220 further includes a counter and a buffer memory 2202. In the present embodiment, the counter further has a high energy pulse counter 2200 and a low energy pulse counter 2201. The counter receives the clock pulse 52 and the logical pulse 51 and takes the logical pulse 51 as a gating signal while taking the clock pulse 52 as an input source so as to form the energy counting information. The buffer memory 2202 is coupled to the counter and the portable electrical device 23 for storing the energy counting information that further comprises a high energy counting information and low energy counting information.

The portable electrical device 23, coupled to the measuring and counting unit 22, may receive the energy counting information for post processing and store data. In the embodiment, the portable electrical device 23 is a personal digital assistant (PDA). The PDA is utilized to be an operating platform with a universal asynchronous receiver/transmitter (UART) and wireless transmission so as to make the portable radiation detection apparatus 2 having capability of wireless transmission and providing convenience for the protection personnel executing the inspection routinely under the extremely environment. In addition, alternatively, the portable electrical device 23 may also be a smart phone or cellular phone, but should not be limited those exemplified above.

On the other hand, the pulse counter unit 220 is capable of measuring pulse width (0.5 μs˜50 μs) of positive pulse of low energy or high energy and negative pulse of low energy or high energy and recording counts into the buffer memory 2202. The measuring resolution of the pulse counter unit 220 is 0.05 μs and the basic recording unit is 4×0.05 μs per 1K byte of the buffer memory 2202. The maximum pulse counts for the pulse counter unit 221 are 65535 times. The portable electrical device 23 is capable of acquiring the pulse counts in different range or resetting recording data to zero through RS232, but should not be a limit to the disclosed embodiment, connected to the pulse counter unit 221.

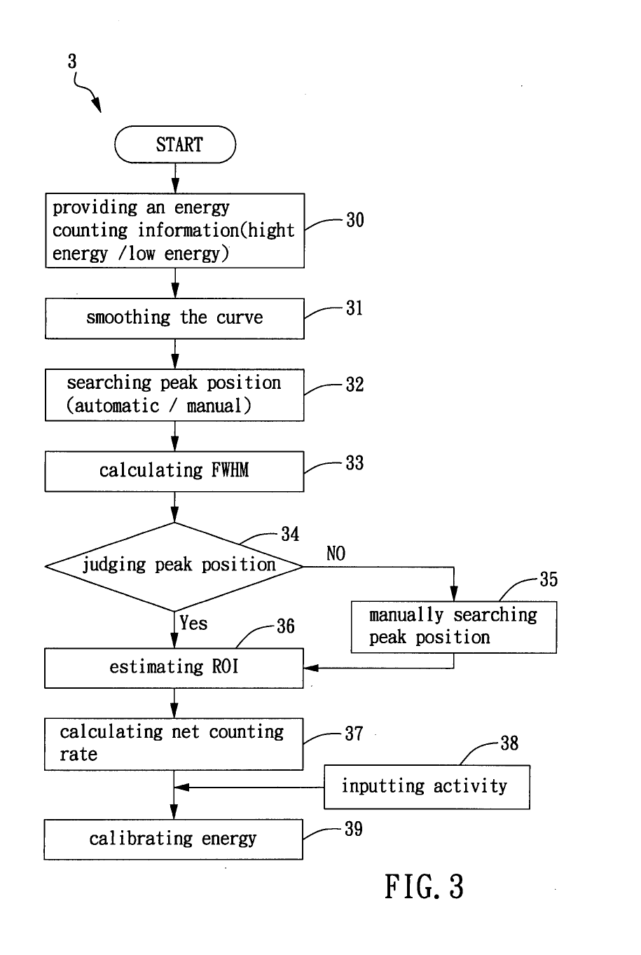

Please refer to FIG. 3, which is a preferred embodiment of spectrometric analysis method according to the present invention. The method 3 is started with a step 30, which provides and stores the energy counting information in the portable electrical device 23, a PDA in the embodiment, for further calculating and processing. The energy channel related to the spectrum of the energy counting information is classified into high energy, which is notated CH1(i), i=1˜256, and low energy, which is notated CH2(i), i=1˜256.

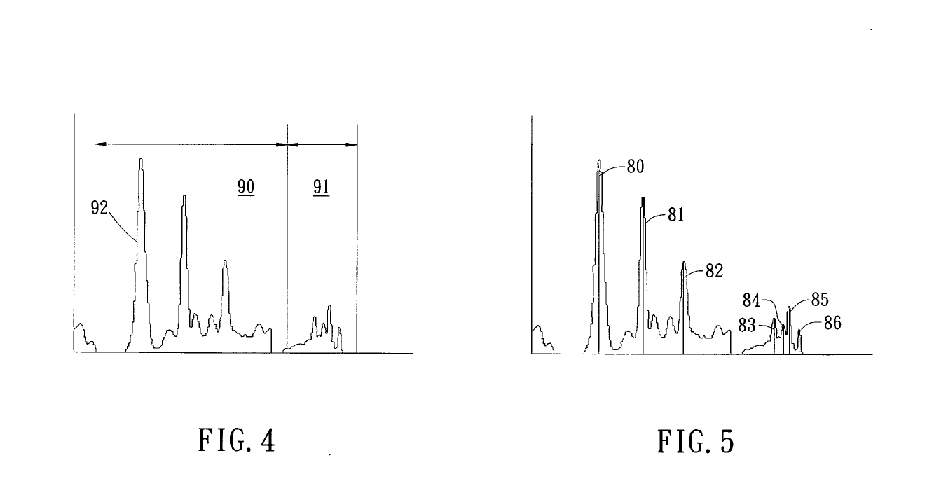

After reading the energy counting information, an analysis program installed in the PDA will chart the energy counting information with high energy channel and low energy channel in the charting area. A chart, shown in FIG. 4, illustrates the result of Eu-152-0308, ¹⁵²Eu, according to the energy counting information. In the FIG. 4, the chart is divided into two parts, wherein one part represents the spectrometric area of high energy 91, and the other part represents the spectrometric area of low energy 90. The two areas are approximately demarcated by 800 Kev.

Next, step 31 is processed to perform post spectrometric analysis toward the energy counting information, wherein a smoothing process is adopted to smooth the energy counting information so as to form a continuous smooth curve. The smoothing process in the embodiment is minimum square method. In the conventional arts, whether a mean value method or weighted mean value method, are intuitive and don't take the trend of the curve into account. However, in the present invention, a characteristic of radioactive decay curve is considered to perform smoothing process by minimum square method, i.e. it is regarded as the curve having characteristic of simple exponential decay so as to eliminate the inaccuracy caused during smoothing process. The equation of the continuous smooth curve is shown in equation (5).

$${a}_{0} = \frac{- 3 {y}_{- 2} + 12 {y}_{- 1} + 17 {y}_{0} + 12 {y}_{1} - 3 {y}_{2}}{35} \qquad ( 5 )$$

After obtaining the continuous smooth curve 92 shown in FIG. 4, a step 32 is processed for searching peak values of the continuous smooth curve 92. In the present invention, it is provided two kinds of searching ways, one is automatic searching peak position and the other is manual searching peak position. In the way of automatic searching, a first derivative of the continuous smooth curve 92 represents the magnitude of slope. At this time, if a second derivative of the continuous smooth curve 92 is further calculated, then a lot of information related to the energy counting information will be obtained. For example, if there is a minimum among the second derivatives of the continuous smooth curve 92 in a specific interval, then it means that a peak position of the continuous smooth curve 92 is possible existing at a location whose second derivative is a minimum.

The smaller of the second derivative of the continuous smooth curve is, the sharper slope of the peak position will be. In another words, if the slope of the peak position is sharp, then it represents that the energy is high in the peak position and the possibility of trueness of the peak position is high as well. In order to ensure that there is a peak position corresponding to the lowest position after differentiating the continuous smooth curve second times, it preferably to take the first derivative of the continuous smooth curve 92 for reference so as to confirm the peak position is actually appear within the specific interval or not. The corresponding equation for the first and the second derivative is show in the following:

first differential equation for the energy counting information

CH′(i)=CH(i+1)−CH(i), i=3˜252

second differential equation for the energy counting information

CH″(i)=CH′(i+1)−CH′(i), i=3˜251

After the first and second differentiating process, a process for sorting the derivatives is proceeded. If there is a relative minimum value after the second differentiating process, then it represents that there is a peak position on the continuous smooth value within the specific interval. The second derivatives of the continuous smooth curve are sorted for the operating analysis in the next. In addition to judge the location of the peak position by the second differentiating process, the first derivatives are also confirmed for ensuring if the minimum value among the second derivatives is a real peak position of the continuous smooth curve or not.

Owing to the left half side of the peak position is an upward slope, first derivative corresponding to the points on the left half side is positive. The larger (positive) the first derivative is, the sharper slope of the left half side will be. On the other hand, the right half side of the peak position is a downward slope and first derivative corresponding to the points on the right half side is negative. The smaller (negative) the first derivative is, the sharper slope of the right half side will be. According to the characteristics described above, if the first derivatives are sorted from large to small, then the result is useful for assisting the judgment of the second derivatives so as to affirm the true or false of the peak position.

After sorting the first derivatives and second derivatives of the continuous smooth curve 92, the lowest twenty of the second derivatives of the continuous smooth curve 92 are picked up for determination, which are notated as DD(j), j=1˜20. Besides, the lowest and top twenty of the first derivatives are selected and notated as PD(k) and ND(k) respectively, wherein k is 1˜20. Finally, for each DD(j), it is determined that if a energy channel corresponding to any one of the value of PD(k) and ND(k) falls in the range of DD(j)±5, then it is affirmed that there will be a peak position within the DD(j)±5.

Please refer to FIG. 5, which illustrates the result of the automatic searching peak position according to the present invention. In the FIG. 5, it is capable of finding the top three peak positions 80, 81, and 82 in the spectrometric area of low energy, while there are four peak positions 83, 84, 85, and 86 in the spectrometric area of high energy. On the other hand, in the spectrometric area of low energy, there are still another peak positions which are filtered out by step 32. Because the top three peak positions 80, 81, and 82 have higher energy channel and occupy at least one of DD(j) values, the other peak positions, being false peak positions, will be filtered out during the process of step 32.

After searching the peak positions, a step 33 of finding full width half maximum (FWHM) value for each peak positions is processed for confirming whether the peak positions being found by step 32 are true or not. If it can't find the FWHM value within the range of energy channel ±10 with respect to the peak value for each peak position, then the peak position does not comply with the requirement of the peak position and should be eliminated. The related program for calculating FWHM value is shown below, wherein the PEAK represents the peak value of the corresponding peak position, PEAKCH represents the energy channel with respect to the peak position, LHM refers to the half maximum value of left side of the peak position, and RHM refers to the half maximum value of right side of the peak position. Then the step 34 is proceeded to confirm that if the LHM and RHM are both capable of being found or not. If the LHM and RHM could be found, then the peak position has a FWHM value; otherwise the peak position is judged as a false peak position.

$$\begin{matrix}HM = PEAK / 2 \\ I = PEAKCH \\ For j = I To I - 10 \\ If CH ( j ) < HM LHM = CH ( j ) \\ For j = I To I + 10 \\ If CH ( j ) < HM RHM = CH ( j ) \\ If RHM > 0 And LHM > 0 FWHM = LHM - RHM \\ Else \\ FWHM = 0 \\ PEAKCH = 0\end{matrix}$$

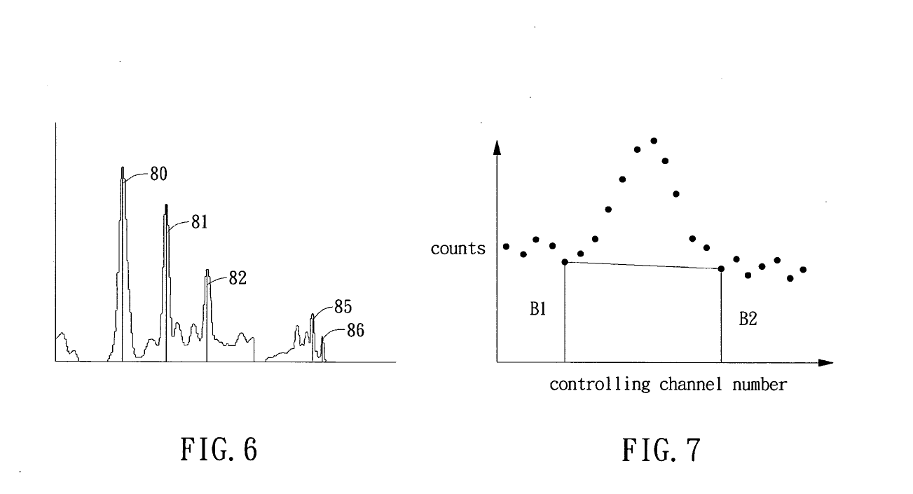

Back to the FIG. 5, which represents result of automatic search peak position of ¹⁵²Eu by step 32, wherein the top three peak positions 80, 81, and 82 in the spectrometric area of low energy, while there are four peak positions 83, 84, 85, and 86 in the spectrometric area of high energy. However, as shown in FIG. 6, after processing the step 34 to calculate the FWHM values for each possible peak positions, there remains only two peak position 85 and 86 in the spectrometric area of high energy. It is because that some peak positions of the ⁵²Eu in the spectrometric area of high energy overlap with each other, the overlapped peak positions are judged as false peak positions after step 34, which is a erroneous judgment of the program. Therefore, in some case, for avoiding such situation occurring, the present invention also provides a manual searching peak position for operator to determine so as to eliminate the error caused by the overlap of peak positions.

When a situation of the overlap of peak positions is occurred, the automatic searching can't find the peak positions accurately, and the FWHM calculation may also filter out some true peak positions; therefore, the step 35 is provided for deciding peak position so as to eliminate the error by operator. When operator is proceeding the manual searching peak positions, there are three actions including “searching peak position”, “deleting peak position”, and “accepting all peak position”, for operating selection toward the continuous smooth curve by user.

After selecting peak positions and calculating FWHM values, it is further to process the step 36 for calculating region of interest (ROI) for each of the peak positions. For each peak position having a FWHM value, the range of the ROI is 1.5 times the FWHM value. Since the FWHM=2\sqrt{2ln2}σ=2.355σ, the 1.5 times the FWHM value is around 3.5σ, and the reliability is about 99.9% which is a pretty high accuracy. The program for calculating ROI is shown below.

$$\begin{matrix}I = PEAKCH \\ For j = I - 1.5 * FWHM To I \\ LROI = min \{ CH ( j ) \} \\ For j = I To I + 1.5 * FWHM \\ RROI = min \{ CH ( j ) \}\end{matrix}$$

As to the peak positions without FWHM values, i.e. the peak positions found by the manual search, the ROI may only be obtained through estimating the energy channel numbers. According to the data statistics, the range for calculating ROI of the peak positions found by manual search is selected around 20 energy channels at left and right side respectively, and the program is described below.

$$\begin{matrix}For j = I To I - 20 \\ LROI = min \{ CH ( j ) \} \\ For j = I To I + 20 \\ RROI = min \{ CH ( j ) \}\end{matrix}$$

In order to avoid the ROI calculation affected by the other peak positions, in addition to calculate the minimum value, a judging program is also provided for assisting the search of peak positions, in which the program will continue to search only when the energy channel numbers are sorted in descending order. If the energy channel numbers are sorted in ascending order, i.e. a next peak position is appear, then the program will continue to search downwardly so as to avoid estimating the next peak position.

After calculating ROI, a step 37 is proceeded for calculating a net counting rate of peak positions. Generally, a distribution of the spectrum is an independent full energy peak formed on the background or Compton continuous area, which is shown in FIG. 7, wherein B1 represents left ROI, B2 represents right ROI, and the area between B1 and B2 represents the background value. Hence, the net area of the energy peak can be shown in equation (6), wherein

$${\sum }_{i = {B}_{1}}^{{B}_{2}} {C}_{i}$$

is a total area under left ROI to right ROI,

$$( {B}_{2} - {B}_{1} ) \frac{{B}_{1} + {B}_{2}}{2}$$

is the background value.

$${N}_{P} = {\sum }_{i = {B}_{1}}^{{B}_{2}} {C}_{i} - ( {B}_{2} - {B}_{1} ) \frac{{B}_{1} + {B}_{2}}{2} \qquad ( 6 )$$

Since the spectrum value is base on the counting for each energy channel, the net area of the energy peak is defined as the net counting value. The net counting rate is obtained by dividing the net counting value to the measuring time interval, which is described as following:

$$Net counting rate = \frac{Net counting value}{Time interval} \qquad ( 7 )$$

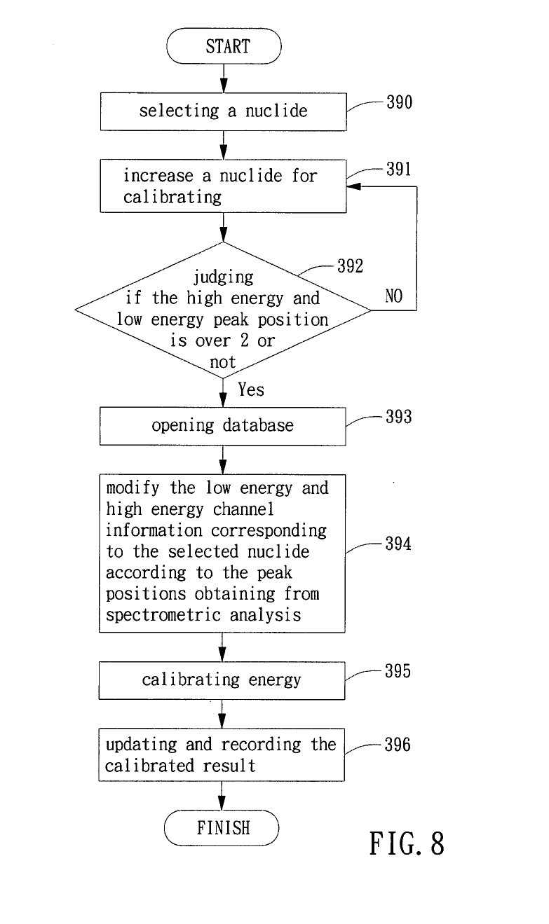

After the step 37, step 38 and step 39 are performed to calibrate energy. As shown in FIG. 8, which is a flow chart of the calibrating energy according to the present invention, the calibrating method in the embodiment of the present invention is a least-squares method for calibrating the relationship between the energy logarithm and the energy channel. Since linear is the basic model of the least squares method, a linear equation y=ax+b can be utilized for describing the relation between the energy logarithm, notated as y, and peak position, notated as x, wherein “a” refers to slope and “b” refers to intercept. The target of the least squares method is to make the square summation of the error to be a minimum. The formula for minimizing the square summation of the error is shown as below equation (8).

$$E = {\sum }_{i = 1}^{n} {[ {y}_{i} - ( a {x}_{i} + b ) ]}^{2} \qquad ( 8 )$$

According to the equation (8), a partial differential result is shown in equation (9) and (10).

$$\begin{matrix}\frac{\partial E}{\partial a} = 0 = 2 {\sum }_{i = 1}^{n} ( {y}_{i} - {ax}_{i} - b ) ( - {x}_{i} ) & ( 9 ) \\ \frac{\partial E}{\partial b} = 0 = 2 {\sum }_{i = 1}^{n} ( {y}_{i} - {ax}_{i} - b ) ( - 1 ) & ( 10 )\end{matrix}$$

After that, equation (11) and (12) are obtained through normalizing the equation (9) and (10).

$$\begin{matrix}a = {\sum }_{i = 1}^{n} {x}_{i}^{2} + b {\sum }_{i = 1}^{n} {x}_{i} = {\sum }_{i = 1}^{n} {x}_{i} {y}_{i} & ( 11 ) \\ a {\sum }_{i = 1}^{n} {x}_{i} + bn = {\sum }_{i = 1}^{n} {y}_{i} & ( 12 )\end{matrix}$$

Then, coefficient a, representing slope, and b, representing intercept, in the equation (11) and (12) can be solved by the rule of Cramer, which are both shown in the following equation (13) and (14), wherein y̅ is the average of y and x̅ is average of x.

$$\begin{matrix}slope a = \frac{n \sum {x}_{i} {y}_{i} - \sum {x}_{i} \sum {y}_{i}}{n \sum {x}_{i}^{2} - {( \sum {x}_{i} )}^{2}} & ( 13 ) \\ intercept b = \frac{\sum {x}_{i}^{2} \sum {y}_{i} - \sum {x}_{i} {y}_{i} \sum {x}_{i}}{n {\sum }_{i}^{2} - {( \sum {x}_{i} )}^{2}} = \overline{y} - a \overline{x} & ( 14 )\end{matrix}$$

According to the foregoing equations, the calibrating equations are shown in the following equations (15), (16), and (17), wherein the SLOPE represents the slope, “x” represents peak position, “y” represents energy logarithm of the corresponding peak position, INTERCEPT represents intercept, N represents the calibrated peak position, and LN(E), the same as y in equation (16), represents the energy logarithm of the corresponding peak position.

$$\begin{matrix}SLOPE = \frac{n \sum xy - \sum x \sum y}{n \sum {x}^{2} - {( \sum x )}^{2}} & ( 15 ) \\ INTERCEPT = \frac{\sum y}{n} - SLOPE \frac{\sum x}{n} & ( 16 ) \\ N = \frac{LN ( E ) - INTERCEPT}{SLOPE} & ( 17 )\end{matrix}$$

With the calibrating equation of (15), (16), and (17), the calibrated energy and energy channel can be obtained through the calculated peak position and peak value, and a nuclide database, sorted according to the energy of peak position and comprising data of nuclide name, half-life, photon energy, energy logarithm, generating rate, peak position for low energy level, and peak position for high energy level can be built.

The calibrating steps are started at step 390, in which the operator selects an appropriate nuclide according to the measured spectrum. In the present embodiment, nuclide ¹³⁷Cs and ⁶⁰Co are used for explanation. Then step 391 is processed for increasing a nuclide for calibrating. In the embodiment the increased nuclide for calibrating is ⁶⁰Co. Afterward, step 392 is proceeded for judging whether the peak position of low level and high level are over two or not. If the peak positions are over two, then step 393 is started for opening the nuclide database. Next, step 394 is processed to modify the low energy and high energy channel information corresponding to the selected nuclide according to the peak positions obtaining from spectrometric analysis. Afterward, step 395 is performed to calibrate energy. The consequence of step 395, such as slope and intercept related to the low energy and high energy channel, can be updated by recording into database and further be stored in PDA for reference by step 396.

While the embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A portable radiation detection apparatus, comprising:
a detecting unit for absorbing radioactive particles so as to generate an analog signal;
a signal processing unit, coupled to the detecting unit, for converting the analog signal into a logical pulse;
a measuring and counting unit, coupled to the signal processing unit, for measuring pulse width and counting pulse counts of the logical pulse so as to form an energy counting information; and
a portable electrical device, coupled to the measuring and counting unit, for receiving the energy counting information for post processing.

2. The apparatus according to the claim 1, wherein the detecting unit further comprising:
a scintillation detector; and
a photomultiplier tube connected to the scintillation detector.

3. The apparatus according to the claim 2, wherein the scintillation detector is a NaI scintillation detector.

4. The apparatus according to the claim 2, wherein the signal processing unit further comprising:
a high voltage power supply, coupled to the detecting unit, for providing operating voltage to the photomultiplier tube so that the photomultiplier tube is capable of converting optical pulse generated from radioactive energy absorbed by the scintillation detector into the analog pulse signal; and
a discriminator circuit for filtering noises of the analog pulse signal and converting the analog pulse signal into the logical pulse.

5. The apparatus according to the claim 1, wherein the portable electrical device is a personal digital assistance.

6. The apparatus according to the claim 1, wherein the portable electrical device is a cellular phone.

7. The apparatus according to the claim 1, wherein the portable electrical device is a smart phone.

8. The apparatus according to the claim 1, wherein the measuring and counting unit further comprising:
a clock pulse generator for generating at least one clock pulse; and
a pulse counter unit, further including:
a counter for receiving the clock pulse and the logical pulse wherein the counter is capable of taking the logical pulse as a gating signal and taking the clock pulse as an input source for counting so as to form the energy counting information; and
a buffer memory, coupled to the counter and the portable electrical device, for storing the energy counting information.

9. The apparatus according to the claim 8, wherein the counter further including a high energy pulse counter and a low energy pulse counter.

10. The apparatus according to the claim 1, wherein the energy counting information further including a high energy counting information and low energy counting information.

11. A method for spectrometric analysis comprising steps of:
providing an energy counting information acquired by a portable radiation detection apparatus;
smoothing the energy counting information so as to form a continuous smooth curve;
searching at least one peak position from the continuous smooth curve, wherein each of the peak position has a corresponding peak value;
calculating a region of interest with respect to each of the peak value; and
calculating a net counting rate according to the region of interest for each of the peak value.

12. The method according to the claim 11, wherein the step of searching at least one peak position further comprising the steps of:
differentiating the continuous smooth curve for searching peaks of the continuous smooth curve; and
determining if the selected peak is the peak position or not.

13. The method according to the claim 12, wherein algorithm for determining if the selected peak is the peak position or not is a Full Width Half Maximum algorithm.

14. The method according to the claim 11, wherein the step of searching at least one peak position further comprising the steps of:
selecting peak from the continuous smooth curve and calculating peak value corresponding to the selected peak; and
determining if the selected peak is the peak position or not.

15. The method according to the claim 14, wherein algorithm for determining if the selected peak is the peak position or not is a Full Width Half Maximum algorithm.

16. The method according to the claim 11, further comprising a step of calibrating energy.

17. The method according to the claim 16, wherein the calibrating further comprises steps of:
selecting a nuclide for calibrating; and
modifying the energy and channel information corresponding to the selected nuclide.
